(19) United States
(12) Patent Application Publication
(10) Pub. No.: US 2026/0112927 A1
(43) Pub. Date: Apr. 23, 2026

(54) FUEL PUMP BRUSHLESS DIRECT CURRENT MOTOR

(71) Applicant: PV CLEAN MOBILITY TECHNOLOGIES PRIVATE LIMITED, Gurugram (IN)

(72) Inventors: Vikas KUMAR, Gurugram (IN); Nitin YADAV, Gurugram (IN); Akash DEVADHIA, Gurugram (IN); Nakul YADAV, Gurugram (IN); Vishal SHARMA, Gurugram (IN); Manish AHLAWAT, Gurugram (IN)

(21) Appl. No.: 19/004,576

(22) Filed: Dec. 30, 2024

(30) Foreign Application Priority Data
Oct. 22, 2024 (IN) 202411080241

(51) Int. Cl. H02K 1/2706; H02K 1/02

(52) U.S. Cl. CPC H02K 1/2706; H02K 1/02

(57) ABSTRACT

A fuel pump brushless direct current motor (100), comprising: a housing assembly (1), a stator assembly (2), and a rotor assembly (3). The rotor assembly (3) includes a shaft (4), a pair of magnets (5), a sleeve ring (6) and an over molding structure (7), the sleeve ring (6) is provided over the pair of magnet (5) for shielding the pair of magnets (5) thereby preventing wear and tear of the pair of magnets (5), and the shaft (4), the pair of magnets (5), sleeve ring (6) are over molded via the over molding structure (7) for providing a protection from the set of external factors. The rotor assembly (3) include a slotted spring pin (10) for increasing torque strength and extending a cyclic life and said slotted spring pin (10) facilitates in reinforcing a drive dog area (11), thereby providing strength to the drive dog area (11).

### FIELD OF THE INVENTION

The present invention relates to a field of mechanical devices. More particularly, the present invention relates to a fuel pump brushless direct current (BLDC) motor with enhanced, durable and efficient rotor assembly for reducing the potential risk associated with the rotor assembly and increasing the lifespan of the rotor assembly and the whole fuel pump brushless direct current (BLDC) motor.

### BACKGROUND OF THE INVENTION

Brushless direct current (BLDC) motors are synchronous motors that utilizes direct current (DC) electric power supply. It uses an electronic controller to switch DC currents to the motor windings, producing magnetic fields that effectively rotate in space and which the permanent magnet rotor follows. It is widely used in various high-performance applications, including liquid fuel pumps, aerospace systems, and industrial machinery, due to their superior efficiency, reliability and low maintenance needs. A BLDC motor consists of two primary components, i.e. a stator and a rotor. The stator generates a controlled electromagnetic field, while the rotor is equipped with permanent magnet segments. These magnets are arranged on the rotor to create a rotating magnetic field that interacts with the magnetic field of the stator assembly, resulting in smooth and efficient motion.

In conventional BLDC motor assemblies, the permanent magnet segments are secured to the rotor using annular ring that is subjected to an electromagnetic forming process. This technique involves deforming the ring to apply a uniform compressive force on the magnet segments. Thereby holding them firmly in place. While, this method is effective in securing the magnets and ensuring their stability during operation, it does not address several critical aspects related to long term durability and environmental resilience.

Existing approaches often overlook the impact of external environmental factors such as exposure to corrosive substances, extreme temperature and mechanical vibrations, which can compromise the integrity of the magnet attachment over time. Moreover, the current methods may not provide adequate protection against contaminants or mechanical stresses that could lead to premature failure of the motor components.

U.S. Pat. No. 8,778,129B2 details a method for adhesively bonding magnets onto the surface or into slots of a rotor or a stator in electric motors or generators. The method involves the pre coating the magnet or the rotor/stator with an adhesive that is non liquid at room temperature and requires activation through heating or high-energy radiation to cure. The adhesive includes reactive epoxy prepolymers, latent hardeners, and elastomers to ensure robust bonding. While, this method provides a strong adhesive bond and includes features such as volume expansion of adhesive and temperature-controlled curing. However, it does not address protective measure that could shield the adhesive from exposure to challenging environment, such as fuel or significant temperature fluctuations. Furthermore, the method does not incorporate additional structural components that could enhance the performance of the adhesive bond in demanding operational conditions. The absence of these protective features limits the method's effectiveness in extending the lifespan and reliability of the magnet assembly in applications subject to continuous exposure to harsh substances.

U.S. Pat. No. 7,847,457B2 discloses a brushless direct current (BLDC) electric motor assembly used in liquid fuel pumps and the like, said motor assembly comprising a stator for producing a controlled electro-magnetic field, a shaft supported for rotation about said longitudinal axis and a plurality of permanent magnet segments supported on outer surface of the shaft's hub. These magnet segments arranged side-by-side and secured by an annular ring that has been deformed using an electromagnetic forming operation to exert uniform compression on the magnet segments. This configuration ensures that the magnet segments are held securely in place. While the assembly achieves effective magnetic retention through uniform compression and anti-rotation lugs, it lacks additional protective features such as such as sleeve ring, to enhanced shielding against environmental factors and longevity and performance of the assembly in demanding applications. This method does not address potential issues related to exposure to external elements like fuel, which may affect the adhesive bond over extended use.

Despite the significant advancements, several critical challenges remain unresolved, particularly regarding the long-term durability of rotor assemblies in fuel pump applications. One of the primary issues is the gradual degradation of the adhesive bond between the magnet and the rotor shaft, which can occur due to continuous exposure to fuel and the fluctuating temperatures inherent in motor operation. Over time, this degradation leads to a weakening of the magnet's attachment to the shaft, resulting in decreased motor efficiency, increased mechanical wear, and the potential for motor failure. Additionally, the current protective over-molding processes, while effective to some extent, do not completely prevent fuel from seeping into micro-gaps or pores in the over-molded material, which can still lead to adhesive degradation. The existing structures also do not fully address the mechanical stresses imposed on the adhesive bond during motor operation, especially under high rotational speeds and load conditions. These shortcomings highlight the need for a more robust solution that can better protect the adhesive bond and enhance the overall reliability of the rotor assembly in BLDC motors used in fuel pump operations.

Therefore, there is a need for a fuel pump brushless direct current (BLDC) motor with enhanced, durable and efficient rotor assembly.

### OBJECT OF THE INVENTION

The main object of the present invention is to provide a fuel pump brushless direct current (BLDC) motor with enhanced, durable and efficient rotor assembly thereby reducing the potential risk associated with the rotor assembly and increasing the lifespan of the rotor assembly.

Another object of the present invention is to provide a motor that protect the adhesive bonding between the components which aids in improving the overall performance of the motor.

Yet another object of the present invention is to provide a motor that represents a significant improvement in the performance and reliability used in fuel pump applications.

Yet another object of the present invention is to provide a motor the assembly of which is encapsulated by a protective means that provides additional level of defence against fuel elements, thereby prolonging the lifespan of the motor.

Still another object of the present invention is to provide a motor that prevents the wear and tear on the motor and ensures the longevity and performance efficiency over extended periods of use.

### SUMMARY OF THE INVENTION

The present invention relates to a fuel pump brushless direct current (BLDC) motor that represents a significant improvement in the performance and reliability.

In an embodiment, the present invention provides a housing assembly, a stator assembly and a rotor assembly. The rotor assembly includes a shaft, a pair of magnets, a sleeve ring and an over molding structure. The sleeve ring is provided over the pair of magnets for shielding the pair of magnets from a set of external factors, thereby preventing wear and tear of the pair of magnets. The shaft, pair of magnets, sleeve ring are over molded via the over molding structure for providing a protection from the set of external factors. The rotor assembly include a slotted spring pin for increasing torque strength and extending a cyclic life of the fuel pump brushless direct current motor. The slotted pin facilitates in reinforcing a drive dog area, thereby providing strength to the drive dog area.

In another embodiment, the present invention provides a fuel pump brushless direct current motor, comprising a housing assembly, a stator assembly, and a rotor assembly. The rotor assembly includes a shaft, a pair of magnets, a sleeve ring and an over molding structure, the sleeve ring is provided over the pair of magnets for shielding the pair of magnets from a set of external factors, thereby preventing wear and tear of the pair of magnets, and the shaft, the pair of magnets, sleeve ring are over molded via the over molding structure for providing a protection from the set of external factors. The stator assembly include two sub-assemblies i.e. coil assembly and a printed circuit board (PCB) assembly. Further, the coil assembly include a motor winding and the PCB assembly serves as a central platform for controlling and managing a set of electrical functions of the fuel pump brushless direct current motor. The PCB assembly is encapsulated using a low pressure molding process to provide protection against high pressure molding.

In another embodiment, the present invention provides a fuel pump brushless direct current motor that is manufactured via a method that include the steps of: a) machining the shaft and manufacturing the pair of magnets, b) creating a bond between the pair of magnets, c) pressing the sleeve ring and laser welding the pair of magnets, the shaft and the sleeve ring, d) over molding the shaft, the pair of magnets, sleeve ring, e) performing a grinding operation on a result obtained after completion of step d), f) balancing a resulted obtained upon completion of step e), g) conducting a magnetization action on a result obtained from step f), and thereby obtaining the fuel pump brushless direct current motor and performing testing on the same.

The above objects and advantages of the present invention will become apparent from the hereinafter set forth brief description of the drawings, detailed description of the invention, and claims appended herewith.

### BRIEF DESCRIPTION OF THE DRAWING

An understanding of the fuel pump brushless direct current motor of the present invention may be obtained by reference to the following drawings:

FIG. 1 is an exploded view of fuel pump brushless direct current motor according to an embodiment of the present invention.

FIG. 2 is flow chart of the method for manufacturing of the fuel pump brushless direct current motor according to an embodiment of the present invention.

FIG. 3 is an exploded view of the fuel pump brushless direct current motor, according to an alternate embodiment of the present invention.

FIG. 4 is a sectional view of the fuel pump brushless direct current motor, according to an embodiment of the present invention.

FIG. 5 is another sectional view of the fuel pump brushless direct current motor, according to an embodiment of the present invention.

FIG. 6(a) and FIG. 6(b) are perspective view and top view of the slotted spring pin of the fuel pump brushless direct current motor, according to an embodiment of the present invention.

FIG. 7(a) and FIG. 7(b) are top view and side view of the slotted spring pin as a hollow round pin of the fuel pump brushless direct current motor, according to an embodiment of the present invention.

FIG. 8(a) and FIG. 8(b) are top view and side view of the slotted spring pin as a solid round pin of the fuel pump brushless direct current motor, according to an embodiment of the present invention.

FIG. 9(a) and FIG. 9(b) are top view and side view of the slotted spring pin as a rectangular shape of the fuel pump brushless direct current motor, according to an embodiment of the present invention.

FIG. 10(a) and FIG. 10(b) are top view and side view of the slotted spring pin as a hexagonal shape of the fuel pump brushless direct current motor, according to an embodiment of the present invention.

FIG. 11 is a graphical representation of the robustness and reliability of fuel pump brushless direct current motor.

FIG. 12 is a graphical representation of results obtained from a drive dog failure test of fuel pump brushless direct current motor.

FIG. 13 is a graphical representation depicting increase in torque strength by the addition of the slotted spring pin in the present invention.

FIG. 14 is a graphical representation of increase in life cycle by the addition of the slotted spring pin in the present invention.

FIG. 15 is a graphical representation regarding sleeve ring durability test over benchmarking.

### DETAILED DESCRIPTION OF THE INVENTION

The present invention will now be described hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention relates to a fuel pump brushless direct current (BLDC) motor with enhanced, durable and efficient rotor assembly, thereby reducing the potential risk associated with the rotor assembly and increasing the lifespan of the rotor assembly.

In the preferred embodiment, the present invention provides a fuel pump brushless direct current motor, comprising a housing assembly, a stator assembly, and a rotor assembly, wherein the rotor assembly includes a shaft, a pair of magnets, a sleeve ring and an over molding structure, the sleeve ring is provided over the pair of magnets for shielding the pair of magnets from a set of external factors, thereby preventing wear and tear of the pair of magnets, and the shaft, pair of magnets, sleeve ring are over molded via the over molding structure for providing a protection from the set of external factors.

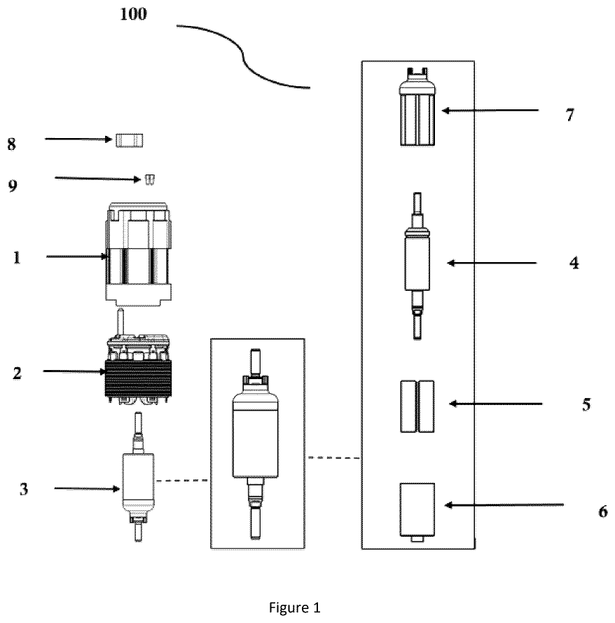

Referring to FIG. 1, an exploded view of fuel pump brushless direct current motor (100) according to an embodiment of the present invention is depicted. The fuel pump motor assembly includes a housing assembly (1), a stator assembly (2), and a rotor assembly (3), a c-connector (8), a sealing insert (9) and associated electronics to control the motor's operation.

The housing assembly (1) used herein encloses the internal components of the brushless direct current motor (100), providing structural integrity and protection from external contaminants. The housing assembly (1) also aids in heat dissipation and provide sound insulation. The stator assembly (2) used herein provides a magnetic field that drives the rotor assembly (3).

The c-connector (8) connect fuel pump assembly and the sealing insert (9) is an accessible port for motor failure assessment.

The rotor assembly (3) includes a shaft (4), a pair of magnets (5), a sleeve ring (6) and an over molding structure (7). The shaft (4) and the pair of magnets (5) are made up of stainless steel for corrosion resistance and sintered neodymium-iron-boron material respectively. The pair of magnets (5) have a magnetic strength in range from 262-286 KJ/m³. Further, the sleeve ring (6) is made up of stainless steel. The shaft (4), the pair of magnets (5) and the sleeve ring (6) used herein are welded via a laser welding process for preventing a contact between the pair of magnets (5) and a fuel.

The shaft (4) is a rotating component that transfers mechanical power from the motor to the connected device, such as a pump. The rotor assembly (3) (which is attached to the shaft (4)) rotates due to the interaction of magnetic fields, thereby driving the shaft (4). The shaft (4) is manufactured through a precise machining process, utilizing SUS420 material. SUS420 is a type of stainless steel known for its excellent corrosion resistance and high strength, making it ideal for applications requiring durability and reliability.

The corrosion resistance of SUS420 decrease significantly if exposed to temperatures above 650° C. However, the rotor assembly (3) operates at maximum 90° C., which does not affect the properties of the material. The tensile strength of SUS420 remains in the range of approximately 850 to 1,000 MPa, meeting our requirements. Although the tensile strength may decrease by about 10-15% at temperatures above 200° C., this reduction does not impact specific requirements of the fuel pump brushless direct current motor (100).

The pair of magnets (5) is usually a permanent magnet located on the rotor assembly (3). In the fuel pump brushless direct current motor (100), the pair of magnets (5) are crucial for creating a magnetic field that interacts with the stator assembly (2), resulting in the rotation of the rotor assembly (3) and the shaft (4). The pair of magnets (5) used in the rotor assembly (3) is composed of sintered Neodymium (NdFeB) magnets. Sintered NdFeB magnets are among the most powerful permanent magnets available, offering high magnetic strength and excellent resistance to demagnetization. This ensures optimal performance and longevity in the fuel pump brushless direct current motor (100).

The NdFeB N35SH magnet, possess properties that protect the NdFeB N35SH magnet from demagnetization at temperatures up to 150° C. With a maximum energy product of 262-286 KJ/m³, the NdFeB N35SH magnet is capable of storing significant energy, resulting in a stronger and more efficient performance.

The sleeve ring (6) used herein, is a protective component that provides insulation or a smooth surface for the shaft (4) to rotate within, reducing friction and wear over time. The sleeve ring (6) also help in maintaining the alignment of the shaft (4) within the housing. The sleeve ring (6) is manufactured through a machining process using SS316L material. SS316L is a grade of stainless steel known for its superior corrosion resistance, especially in harsh environments containing corrosive substances such as fuel. The material used for manufacturing of the sleeve ring (6) enhances the durability and lifespan of the rotor assembly (3).

The components of the rotor assembly (3) as mentioned above are bonded together via a critical bonding process that involves adhering magnets to the shaft (4) using adhesive and then over-moulding the components of the rotor assembly (3), such as the shaft (4) and the pair of magnets (5). During the over-moulding process, a protective material is applied over the shaft (4), the pair of magnets (5), and sleeve ring (6), encapsulating them, and providing an additional layer of protection against external factors such as moisture, chemicals, and mechanical stress. After over-moulding, laser welding between shaft (4) and sleeve ring (6) and magnetization of the rotor assembly (3) is performed to form the fuel pump brushless direct current motor (100).

The rotor assembly (3) undergoes an over molding process using a specific material known as PA66GF43%, which is a polyamide (nylon) reinforced with 43% glass fibers. PA66GF43% material is chosen for its excellent properties, particularly its high thermal resistance and compatibility with fuels such as diesel.

During the over molding process, PA66GF43% material is applied to encapsulate the entire rotor assembly (3), creating a protective layer that shields the rotor assembly (3) from direct contact with external factors, including harsh environmental conditions and chemicals. The over molded layer acts as a barrier, preventing the pair of magnets (5) within the rotor assembly (3) from coming into direct contact with fuel when the pump is in operation.

The use of PA66GF43% is crucial because of its ability to withstand high temperatures and resist degradation when exposed to diesel and other fuels. This ensures that the rotor assembly (3) remain durable and functional over time, protecting the internal components like rotor assembly (3) from potential damage caused by fuel exposure.

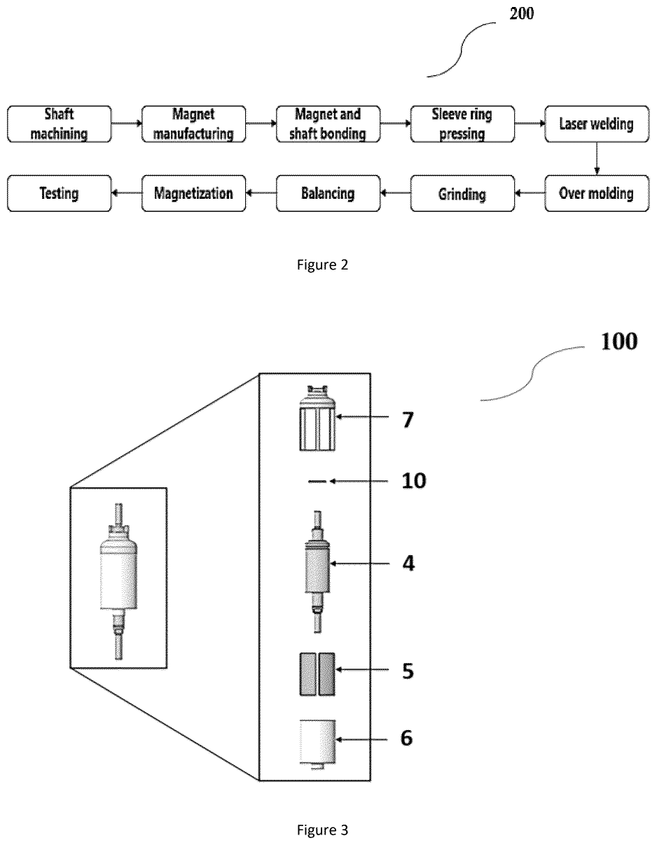

Referring to FIG. 2, a flow chart of the method (200) for manufacturing of the fuel pump brushless direct current motor (100) is depicted according to an embodiment of the present invention. At step (a), the method (200) comprises of machining the shaft (4) and manufacturing the pair of magnets (5). After completion of step (a), the next step (b) involves creating a bond between the pair of magnets (5). In other words, the bond between the pair of magnets (5) are created by adhering the shaft (4) and the pair of magnets (5) to securely fasten the pair of magnets (5) to the shaft (4) using adhesive i.e. initially, the shaft (4), the pair of magnets (5), and sleeve ring (6), are moulded together as a single unit. As a crucial step in the manufacturing process, bonding adhesive is meticulously applied between the shaft (4) and the pair of magnets (5) to securely fasten the pair of magnets (5) to the shaft (4). The afore-mentioned bonding process is essential for maintaining the structural integrity of the rotor assembly (3), especially under operational stresses.

Further at step (c), pressing the sleeve ring (6) and laser welding the pair of magnets (5), the shaft (4) and the sleeve ring (6). In other words, the sleeve ring (6) is introduced between the pair of magnets (5) and the shaft (4) which protect the adhesive bonding, the pair of magnets (5) and the shaft (4) from direct contact with the fuel. Introduction of the sleeve ring (6) increases the lifespan of the rotor assembly (3) and also increases the overall efficiency of the fuel pump brushless direct current motor (100). This ensures that the bonding strength between the pair of magnets (5) and the shaft (4) is maintained over an extended period, contributing to the improved durability, reliability and efficiency of the fuel pump brushless direct current motor (100). After introduction of the sleeve ring (6), the laser welding of the shaft (4) and the sleeve ring (6) is performed.

At step (d), the sleeve ring (6) undergoes over-moulding, a process where the sleeve ring (6) is encapsulated in a protective material, providing an additional layer of defence against external elements. The over molding structure (7) is made of polyamide reinforced with glass fiber. During the over moulding process, a protective material is applied over the shaft (4), the pair of magnets (5), and sleeve ring (6), encapsulating them, and providing an additional layer of protection against external factors such as moisture, chemicals, and mechanical stress. After over molding process, laser welding was performed between the shaft (4) and the sleeve ring (6). This comprehensive manufacturing process ensures the robustness and reliability of the rotor assembly (3) within the fuel pump brushless direct current motor (100) and also prevent the pair of magnets (5) from the fuel.

Further, at step (e), the method (200) performing a grinding operation on a result obtained after completion of step d).

At step (f), the method (200) comprises balancing a resulted obtained upon completion of step e). At step (g), the method (200) comprises conducting a magnetization action on a result obtained from step f), thereby obtaining the fuel pump brushless direct current motor (100) and performing testing of the same. The magnetization step is essential for ensuring that the pair of magnets (5) within the assembly maintain their magnetic properties, optimizing the performance of the fuel pump brushless direct current motor (100). Magnetization enhances the efficiency and reliability of the motor by ensuring consistent magnetic field strength.

A pivotal aspect of the method (200) for manufacturing the fuel pump brushless direct current motor (100) is the magnetization of the pair of magnets (5) within the over-moulded assembly. This magnetization step plays a crucial role in providing enhanced protection against direct contact with fuel, a critical consideration in fuel pump applications.

Thus, it is concluded that in the manufacturing of the brushless direct current motor (100), the rotor assembly (3) does not include an outer sleeve ring (6), which simplifies the manufacturing process, thereby allowing the pair of magnets (5) to be easily attached and magnetized early in the assembly process.

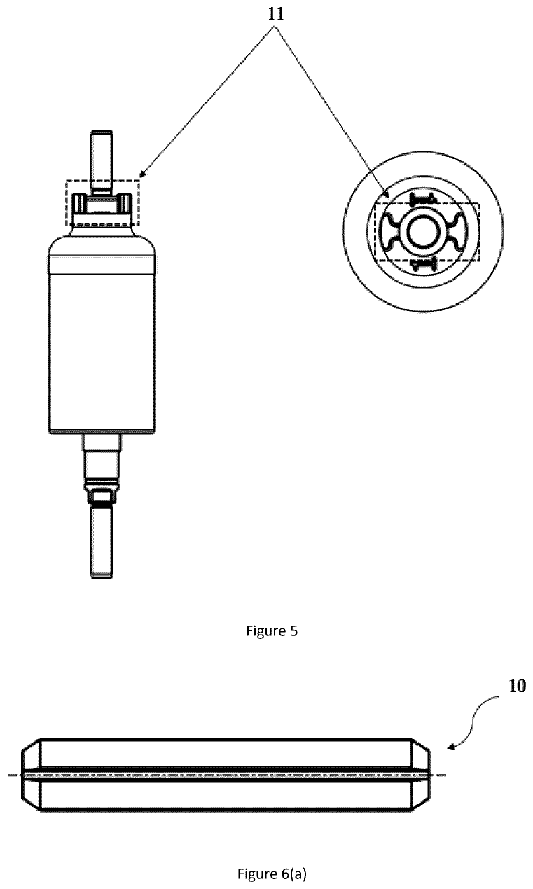

Further, in FIG. 3, an exploded view of the fuel pump brushless direct current motor (100), according to an embodiment of the present invention. The fuel pump brushless direct current motor (100) comprises the housing assembly (1), the stator assembly (2), and the rotor assembly (3), the c-connector (8), the sealing insert (9) and associated electronics to control the motor's operation. Further, in the rotor assembly (3) there is a slotted spring pin (10) that helps increase torque strength and extends the cyclic life of the fuel pump brushless direct current motor (100). The slotted spring pin (10) is specifically used to reinforce the drive dog area (11) (refer to FIG. 5). Further the slotted pin (10) is assembled onto the shaft and then molded with the outer layer during the manufacturing process, providing added strength to the drive dog area (11). Also, an additional hole is incorporated into the shaft (4) to accommodate the assembly of the slotted spring pin (10). The slotted spring pin (10) is then press-fitted into the additional hole.

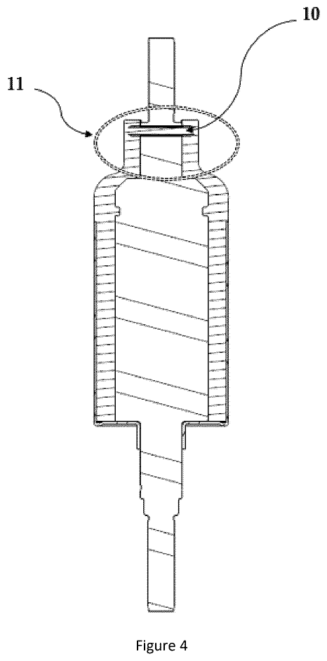

Further, in FIG. 4, a sectional view of the fuel pump brushless direct current motor (100), according to an embodiment of the present invention.

The rotor assembly (3) incorporates the drive dog feature (i.e. drive dog area (11)), which plays a fundamental role in the functionality of the fuel pump brushless direct current motor (100). The drive dog area (11) is strategically located in the g-rotor area of the drive dog area (11) and is configured to generate torque during the operation of the fuel pump brushless direct current motor (100). The torque produced by the drive dog facilitates the efficient lifting and transfer of fuel from the fuel pump brushless direct current motor (100), ensuring an optimal performance.

The structure and material strength of the drive dog area (11) are critical for its effectiveness. The structure of the drive dog area (11) ensures that the feature interacts seamlessly with the impeller of the fuel pump brushless direct current motor (100), reducing mechanical losses and enhancing reliability.

By focusing on these aspects, the drive dog area (11) contributes to the smooth and reliable functioning of the fuel pump brushless direct current motor (100), extending its operational lifespan and maintaining consistent performance under various conditions.

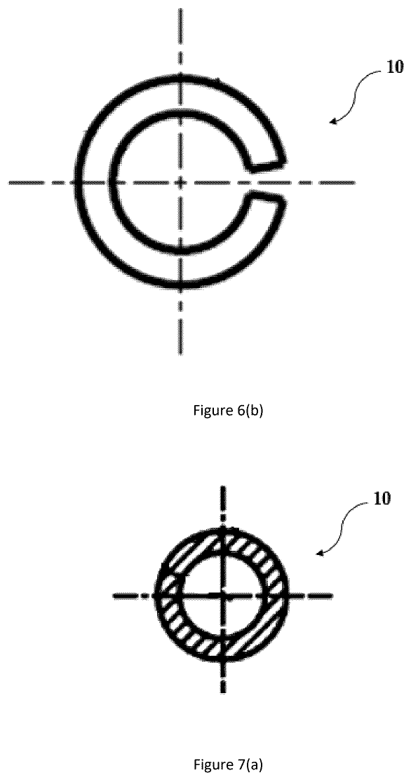

Further, in FIG. 6(a) and FIG. 6(b), a perspective view and a top view of the slotted spring pin (10) of the fuel pump brushless direct current motor (100) is depicted. The slotted spring pin (10) is in at least one of a cylindrical shape, a rectangular shape, a hexagonal with a longitudinal slot that is extended to the length of the slotted spring pin (10). Further the slotted spring pin (10) is at least one of a hollow round pin and a solid round pin.

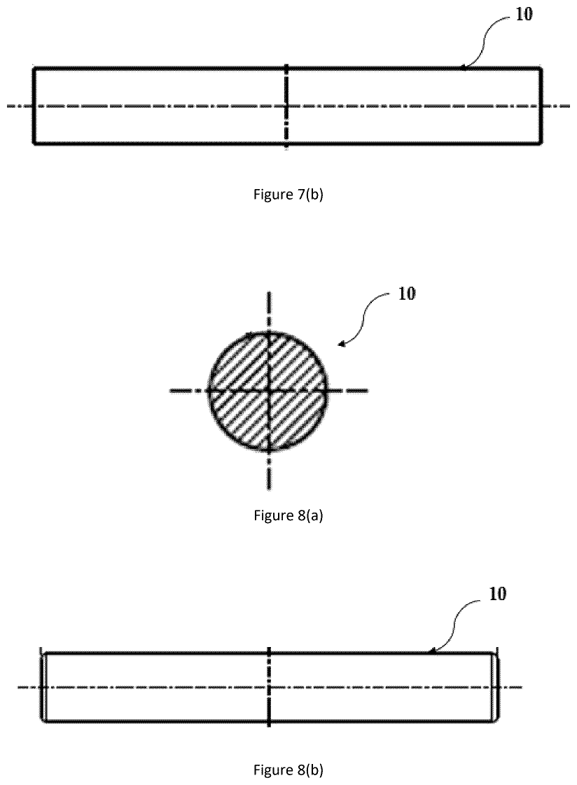

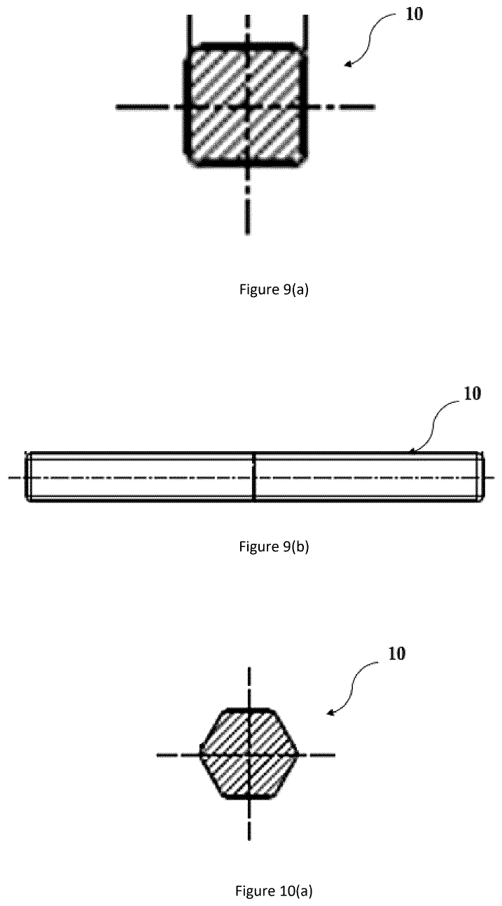

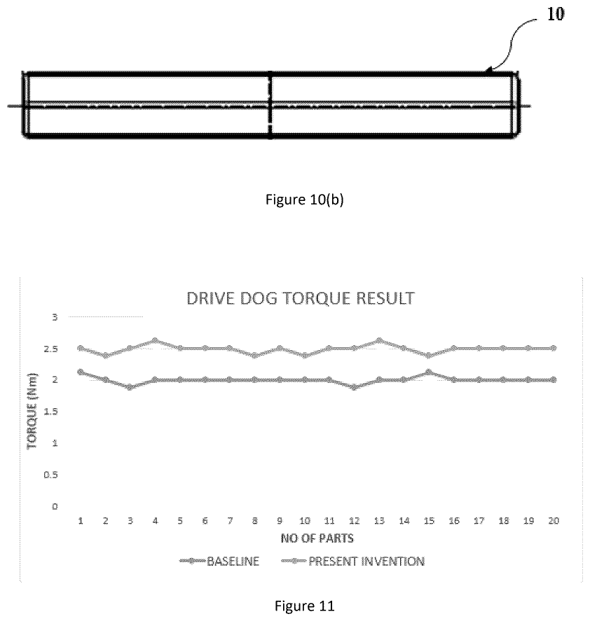

Further, in FIG. 7(a) and FIG. 7(b), a top view and a side view of the slotted spring pin (10) as a hollow round pin are depicted. Further the FIG. 7(a) and FIG. 7(b) depicts an implementation of the slotted spring pin (10) as a hollow round pin. Also, in FIG. 8(a) and FIG. 8(b), a top view and a side view of the slotted spring pin (10) as a solid round pin is depicted. Thereafter, in FIG. 9(a) and FIG. 9(b), a top view and a side view of the slotted spring pin (10) as a rectangular shape are depicted. Additionally, in FIG. 10(a) and FIG. 10(b), a top view and a side view of the slotted spring pin (10) as a hexagonal shape are depicted.

The diameter of the slotted spring pin (10) is in range from 1 mm to 2 mm, and according to a preferred implementation, the diameter is 1.2±0.1 mm.

### EXAMPLE 1

### Experimental Analysis

Referring to FIG. 11, a graphical representation of the robustness and reliability of fuel pump brushless direct current motor (100) is depicted. From the graphical representation, it is evident that the breaking torque of the fuel pump brushless direct current motor (100) surpasses that of the benchmarking samples. This indicates that the manufacturing of the fuel pump brushless direct current motor (100) is superior in terms of robustness and reliability. The higher breaking torque suggests that the present invention withstand greater mechanical stress before failure, demonstrating its enhanced durability and performance under challenging conditions.

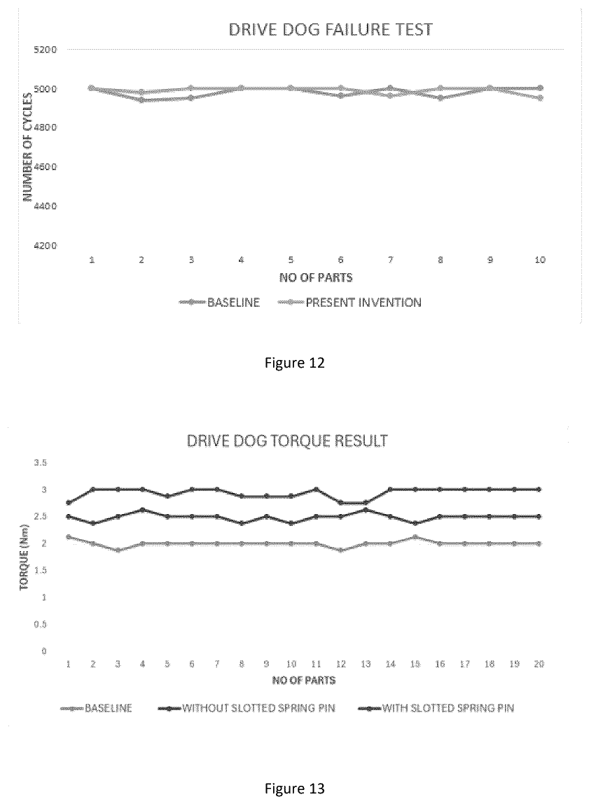

Referring to FIG. 12, a graphical representation of results obtained from a drive dog failure test of fuel pump brushless direct current motor (100) according to an embodiment of the present invention is depicted. Based on the graphical representation illustrating the cyclic test results, the drive dog in the rotor assembly of the present invention demonstrated failure at 5000 cycles under the torque of 1.5 Nm. When compared to the benchmarking samples, the performance of the present invention's drive dog is comparable but, in some cases, superior. This comparison highlights that the present invention excels in terms of both robustness and reliability. This reliability ensures consistent operation over time, making the present invention an optimal choice for applications where durability and performance are critical. Further, longevity and enhanced endurance of the present invention provide a significant advantage, reinforcing the superiority of the structure of the present invention.

Consequently, this makes the present invention more reliable and robust, ensuring consistent performance and longevity compared to the benchmarking samples.

Referring to FIG. 13, a graphical representation of increase in torque strength by the addition of the slotted spring pin in the present invention. Further, through FIG. 13 it is evident that the breaking torque of the present invention (with slotted spring pin) surpasses that of the benchmarking samples and a direct current motor without slotted spring pin. Furthermore, the FIG. 13 indicates that the present invention is superior in terms of robustness and reliability. The higher breaking torque suggests that the present invention is able to withstand greater mechanical stress before failure, demonstrating its enhanced durability and performance under challenging conditions. Consequently, this makes the present invention more reliable and robust, ensuring consistent performance and longevity compared to the benchmarking samples.

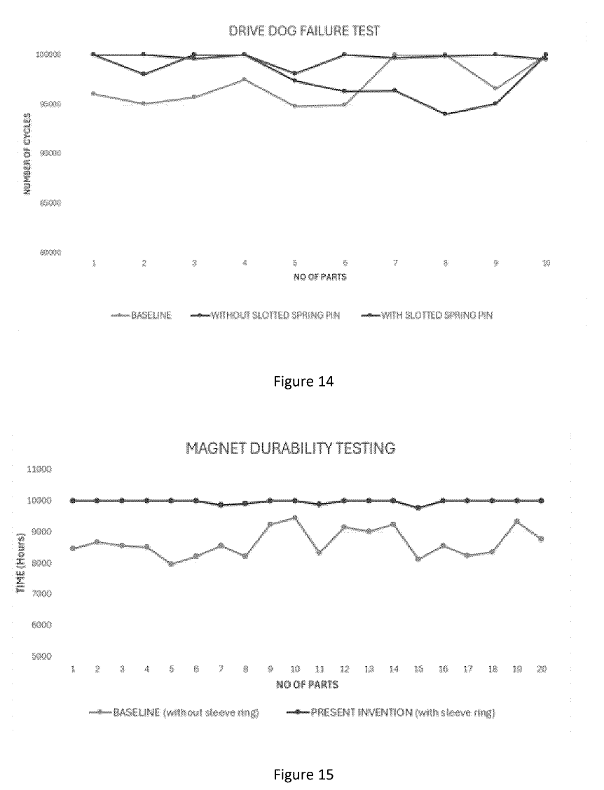

Referring to FIG. 14, a graphical representation of increase in life cycle by the addition of the slotted spring pin in the present invention. In other words, FIG. 14 depicts the cyclic test results, the drive dog feature in the rotor assembly of the benchmark sample i.e. without slotted spring pin) and the present invention with slotted spring pin, a demonstrated failure at 100000 cycles under the torque of 1.5 Nm. When compared to the samples, the performance of the present invention with slotted spring pin is comparable but, in some cases, superior. This comparison highlights that the present invention excels in terms of both robustness and reliability. This reliability ensures consistent operation over time, making the present invention an ideal choice for applications where durability and performance are critical. The longevity and enhanced endurance of the present invention provide a significant advantage, reinforcing the superiority of the structure of the present invention.

The present invention provides that the incorporation of the sleeve ring (6) and the subsequent over molding process in the rotor assembly (3) represents a significant technological advancement. This contribute to the overall efficiency, durability, and reliability of fuel pump brushless direct current motor (100) and pump assemblies, making them suitable for demanding applications in various industries. The introduction of the sleeve ring (6) represents a targeted solution to enhance the durability and reliability of the rotor assembly (3), thereby improving the overall performance of the fuel pump assembly.

Further, introduction of the sleeve ring (6) in the rotor assembly (3) effectively addresses long-term usage failures, increasing the product's lifespan and reducing the likelihood of failures over time. This targeted improvement enhances the durability and reliability of the fuel pump assembly while maintaining the essential requirements and aspects of the fuel pump brushless direct current motor (100). Additionally, the minimal changes required in the manufacturing process facilitate seamless integration, ensuring a smooth transition to the enhanced design.

Referring to FIG. 15, a graphical representation regarding sleeve ring durability test over benchmarking is depicted. A test was conducted for over 10,000 hours of continuous pump operation at 90° C. in diesel to evaluate the bonding strength and durability of the pair of magnets (5). The results indicate that the present invention (i.e. fuel pump brushless direct current motor (100)), demonstrates superior durability. The test revealed that the sleeve ring (6) maintained its integrity throughout the 10,000-hour duration, whereas the benchmark components, which lack a sleeve ring and expose the magnet to direct contact with the fluid, failed earlier. This highlights the durability and performance of the present invention under demanding conditions.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

1. A fuel pump brushless direct current motor (100), comprising:
a housing assembly (1);
a stator assembly (2); and
a rotor assembly (3);
wherein:
said rotor assembly (3) includes a shaft (4), a pair of magnets (5), a sleeve ring (6) and an over molding structure (7);
said sleeve ring (6) is provided over the pair of magnets (5) for shielding the pair of magnets (5) from a set of external factors, thereby preventing wear and tear of the pair of magnets (5);
said shaft (4), pair of magnets (5), sleeve ring (6) are over molded via the over molding structure (7) for providing a protection from the set of external factors;
said rotor assembly (3) include a slotted spring pin (10) for increasing torque strength and extending a cyclic life of the fuel pump brushless direct current motor (100); and
said slotted spring pin (10) facilitates in reinforcing a drive dog area (11), thereby providing strength to the drive dog area (11).

2. The fuel pump brushless direct current motor (100) as claimed in claim 1, wherein the fuel pump brushless direct current motor comprises a c-connector (8), a sealing insert (9).

3. The fuel pump brushless direct current motor (100) as claimed in claim 1, wherein the shaft (4) is made up of stainless steel for corrosion resistance.

4. The fuel pump brushless direct current motor (100) as claimed in claim 1, wherein the pair of magnets (5) is made up of sintered neodymium-iron-boron material.

5. The fuel pump brushless direct current motor (100) as claimed in claim 1, wherein the pair of magnets (5) have a magnetic strength in range from 262-286 KJ/m³.

6. The fuel pump brushless direct current motor (100) as claimed in claim 1, wherein the sleeve ring (6) is made up of stainless steel.

7. The fuel pump brushless direct current motor (100) as claimed in claim 1, wherein the shaft (4), pair of magnets (5) and the sleeve ring (6) are welded via a laser welding process for preventing a contact between the pair of magnets (5) and a fuel.

8. The fuel pump brushless direct current motor (100) as claimed in claim 1, wherein the slotted spring pin is press-fitted into an additional hole that is drilled in the shaft (4).

9. The fuel pump brushless direct current motor (100) as claimed in claim 1, wherein the slotted spring pin (10) is in at least one of a cylindrical shape, a rectangular shape, a hexagonal with a longitudinal slot that is extended to the length of the slotted spring pin (10).

10. The fuel pump brushless direct current motor (100) as claimed in claim 1, wherein the slotted spring pin (10) is at least one of a hollow round pin and a solid round pin.

11. The fuel pump brushless direct current motor (100) as claimed in claim 1, wherein the diameter of the slotted spring pin (10) is in range from 1 mm to 2 mm.

12. The fuel pump brushless direct current motor (100) as claimed in claim 1, wherein said slotted spring pin (10) extends the cyclic life of the fuel pump brushless direct current motor (100) up to 100000 cycles.

13. The fuel pump brushless direct current motor (100) as claimed in claim 1, wherein the over molding structure (7) is made of polyamide reinforced with glass fiber.

14. The fuel pump brushless direct current motor (100) as claimed in claim 1, wherein the set of external factors include fuel exposure, dust exposure or harsh environmental conditions.

15. The fuel pump brushless direct current motor (100) as claimed in claim 1, wherein the fuel pump brushless direct current motor is manufactured via a method (200) including the steps of:
a) machining the shaft (4) and manufacturing the pair of magnets (5);
b) creating a bond between the pair of magnets (5);
c) pressing the sleeve ring (6) and laser welding the pair of magnets (5), the shaft (4) and the sleeve ring (6);
d) over molding the shaft (4), pair of magnets (5), sleeve ring (6);
e) performing a grinding operation on a result obtained after completion of step d);
f) balancing a resulted obtained upon completion of step e); and
g) conducting a magnetization action on a result obtained from step f), and thereby obtaining the fuel pump brushless direct current motor.
